(19) United States
(12) Patent Application Publication
(10) Pub. No.: US 2012/0068494 A1
(43) Pub. Date: Mar. 22, 2012

(54) Heat insulation sheet for vehicles

(76) Inventor: Chin-Chien Chien, Nantou County (TW)

(21) Appl. No.: 12/807,990

(22) Filed: Sep. 16, 2010

(51) Int. Cl. B60R 13/08

(52) U.S. Cl. 296/39.3

(57) ABSTRACT

A heat insulation sheet includes a water-proof and heat insulation sheet and four positioning portions on four sides thereof. Each of the four positioning portions has positioning members, such as magnets or suction disks, connected thereto so that when the sheet is mounted to the vehicle, the positioning members are secured to the vehicle to position the sheet onto the vehicle. Two resilient members are connected to two sides of the sheet and hook to rearview mirrors of the vehicles.

### FIELD OF THE INVENTION

The present invention relates to a heat insulation sheet, and more particularly, to a heat insulation sheet for conveniently mounted and secured to the vehicle.

### BACKGROUND OF THE INVENTION

Due to the global warming, the weather changes severely and the temperature of the earth becomes higher than ever. The higher temperature surely gives an impact to people's everyday life, the drivers for example, have to deal with the high temperature when they park their cars outside of buildings and do not have any shade to avoid from the sun. All of the windows of the cars are closed so that each car forms an enclosed space, that means no air ventilation and the heat is trapped in the car. After eight hours of exposure under the sun, the temperature in the cars can easily reach 70 degrees Celsius so that the drivers cannot bear the high temperature to drive.

In addition, some parts of the cars can be damaged under high temperature and the maintenance fees will increased. This is another type of wasting and the replaced auto parts pollute the earth.

The present invention intends to provide a heat insulation sheet which is easily to be covered onto the car and easily to be collected and stored.

### SUMMARY OF THE INVENTION

The present invention relates to a heat insulation sheet and comprises a water-proof and heat insulation sheet which includes multiple positioning members respectively connected to four sides of the sheet and the positioning members can be magnets or suction disks so as to be secured to the vehicles. Multiple resilient members are connected to two sides of the sheet and hook to protruding parts of the vehicles to further secure the sheet on the vehicles.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a top view of the heat insulation sheet of the present invention;

FIG. 2 is a top view to show that the heat insulation sheet of the present invention is mounted to the car;

FIG. 3 is a side view to show that the resilient members of the heat insulation sheet of the present invention hook to the rearview mirrors of the car, and

FIG. 4 shows that the heat insulation sheet of the present invention is folded and bound by the resilient members.

### DETAILED DESCRIPTION OF THE PREFERRED EMBODIMENT

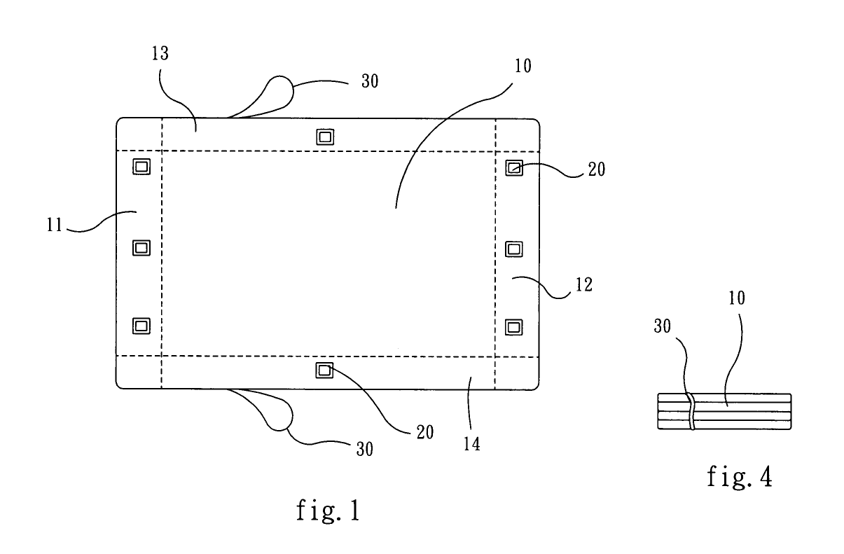

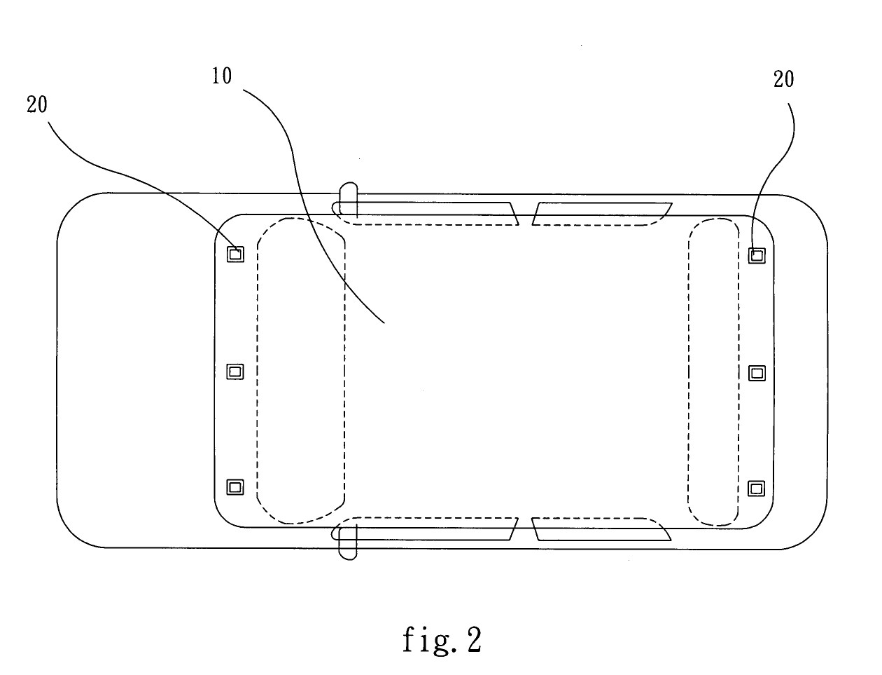

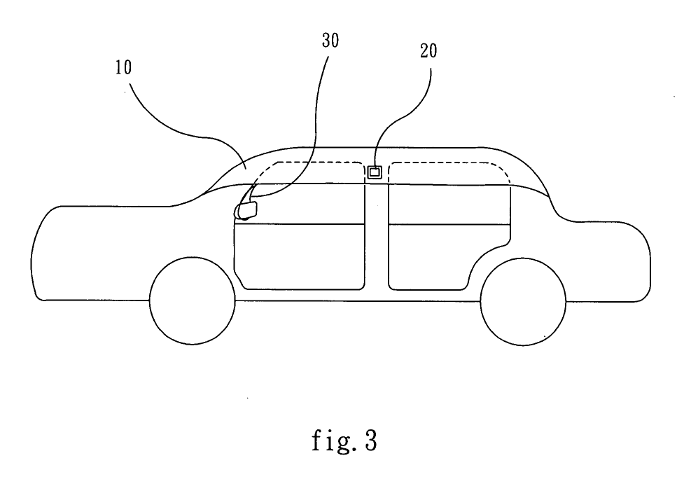

Referring to FIGS. 1 to 3, the heat insulation sheet of the present invention comprises a water-proof and heat insulation sheet 10 which includes a first positioning portion 11 and a second positioning portion 12 respectively located on two first opposite sides thereof, and a third positioning portion 13 and a fourth positioning portion 14 respectively located on two second opposite sides thereof. The first and second positioning portions 11, 12 are located in opposite to each other, and the third and fourth positioning portions 13, 14 are located in opposite to each other. In other words, the sheet 10 is a rectangular sheet.

Multiple positioning members 20 are respectively connected to the first, second, third and fourth positioning portions 11, 13, 13, 14, wherein there are three positioning members 20 evenly connected to the first and second positioning portions 11, 12. One positioning member 20 is connected to a mediate portion of the third positioning portion 13 and another one of the positioning member 20 is connected to a mediate portion of the fourth positioning portion 14. Two resilient members 30 are respectively connected to the third and fourth positioning portions 13, 14 of the sheet 10. The positioning members 20 can be magnets or suction disks, and the resilient members 30 are resilient bands.

When mounting the sheet 10 onto the car, the positioning members 20 on the first and second positioning portions 11, 12 are attached to the hood and the trunk of the car, and the positioning members 20 on the two respective mediate portions of the third and fourth positioning portions 13, 14 are located corresponding to the pillars on two sides of the car so that they are attached to the pillars. The resilient members 30 are hooked to the rearview mirrors protruding from the car to further secure the sheet 10.

The sheet 10 is easily to be mounted onto the car and the positioning members 20 secure the sheet to the car, the resilient members 30 hook to the rearview mirrors can prevent the sheet 10 from being blown off.

As shown in FIG. 4, when collecting the sheet 10, the sheet 10 can be folded to a compact size and bound by the resilient members 30. The collected sheet 10 is easily to be stored and carried. The sheet 10 of the present invention improves all of the shortcomings of the conventional products.

While we have shown and described the embodiment in accordance with the present invention, it should be clear to those skilled in the art that further embodiments may be made without departing from the scope of the present invention.

What is claimed is:

1. A heat insulation sheet comprising:
a sheet;
multiple positioning members respectively connected to periphery of the sheet and the positioning members adapted to be secured to the vehicles, and
multiple resilient members connected to two sides of the sheet and adapted to hook to protruding parts of the vehicles.

2. The heat insulation sheet as claimed in claim 1, wherein the sheet includes a first positioning portion and a second positioning portion respectively located on two first opposite sides thereof, the positioning members are connected to the first and second positioning portions.

3. The heat insulation sheet as claimed in claim 2, wherein the positioning members are evenly connected to the first and second positioning portions.

4. The heat insulation sheet as claimed in claim 2, wherein the sheet includes a third positioning portion and a fourth positioning portion respectively located on two second opposite sides thereof, the positioning members are connected to the third and fourth positioning portions, the resilient members are connected to the two second opposite sides of the sheet.

5. The heat insulation sheet as claimed in claim 4, wherein one of the positioning members is connected to a mediate portion of the third positioning portion and another one of the positioning members is connected to a mediate portion of the fourth positioning portion.

6. The heat insulation sheet as claimed in claim 5, wherein the two respective mediate portions of the third and fourth positioning portions are adapted to be located corresponding to the pillars on two sides of the vehicles.

7. The heat insulation sheet as claimed in claim 1, wherein the positioning members are magnets or suction disks.

8. The heat insulation sheet as claimed in claim 1, wherein the sheet is a water-proof and heat insulation fabric.
